(19) United States
(12) Patent Application Publication
(10) Pub. No.: US 2026/0341048 A1
(43) Pub. Date: Oct. 29, 2026

(54) STORAGE-RETRIEVAL MANAGEMENT SYSTEM AND STORAGE-RETRIEVAL MANAGEMENT METHOD

(71) Applicant: Panasonic Intellectual Property Management Co., Ltd., Osaka (JP)

(72) Inventors: Kazuhiro MOCHINAGA, Osaka (JP); Taku KARIYAZAKI, Osaka (JP); Wataru SUDA, Tokyo (JP)

(21) Appl. No.: 19/119,004

(22) PCT Filed: Aug. 8, 2023
(86) PCT No.: PCT/JP2023/028907

§ 371 Date: Apr. 7, 2025

(30) Foreign Application Priority Data
Oct. 27, 2022 (JP) 2022-172466

(51) Int. Cl. G06V 20/68; G06Q 10/087; G06V 40/10; G06V 40/20

(52) U.S. Cl. CPC G06V 20/68; G06Q 10/08774; G06V 40/107; G06V 40/28

(57) ABSTRACT

A storage-retrieval management system includes: a video capturer that captures a video of an opening of a refrigerator viewed from above; a food item detector that detects whether a stationary object other than the refrigerator is visible in a first region of the video by performing image processing on the video; a hand and arm detector that detects whether a hand or an arm of a user located in front of the opening is visible in a second region of the video by performing image processing on the video; and a determiner that determines, under a condition that the stationary object other than the refrigerator is detected as being visible in the first region during a period in which the hand or the arm of the user is not visible in the second region, that the stationary object is an object that is subject to inventory management.

### TECHNICAL FIELD

The present disclosure relates to a storage-retrieval management system and a storage-retrieval management method.

### BACKGROUND ART

Conventionally, a technique related to a repository in which objects are stored has been proposed. Patent literature (PTL) 1 discloses a refrigerator that allows for inventory management to be performed for contents of the refrigerator while alleviating user inconvenience, as well as making it possible to reduce wasted effective storage space in the refrigerator and to prevent manufacturing costs from increasing.

### CITATION LIST

### Patent Literature

[PTL 1] Japanese Unexamined Patent Application Publication No. 2015-81762

### SUMMARY OF INVENTION

### Technical Problem

The present disclosure provides a storage-retrieval management system that can determine that an article is an object that is subject to inventory management based on intentional movement of a user.

### Solution to Problem

A storage-retrieval management system according to one aspect of the present disclosure includes: a video capturer that captures a video of an opening of a repository viewed from above; a first detector that detects whether a stationary object other than the repository is visible in a first region of the video by performing image processing on the video; a second detector that detects whether a hand or an arm of a user located in front of the opening is visible in a second region of the video by performing image processing on the video; and a determiner that determines, under a condition that the stationary object other than the repository is detected as being visible in the first region during a period in which the hand or the arm of the user is not visible in the second region, that the stationary object is an object that is subject to inventory management.

### Advantageous Effects of Invention

The storage-retrieval management system according to one aspect of the present disclosure can determine that an article is an object that is subject to inventory management based on intentional movement of a user.

### BRIEF DESCRIPTION OF DRAWINGS

FIG. 1 is a block diagram illustrating a functional configuration of a storage-retrieval management system according to an embodiment.

FIG. 2 is an external view of a refrigerator and a storage-retrieval management device that are included in the storage-retrieval management system according to the embodiment.

FIG. 3 is a first diagram illustrating a video captured by a video capturer.

FIG. 4 is a second diagram illustrating the video captured by the video capturer.

FIG. 5 is a third diagram illustrating the video captured by

FIG. 6 is a fourth diagram illustrating the video captured by the video capturer.

FIG. 7 is a state transition diagram of four states used in inventory management of food items.

FIG. 8 is a block diagram of a functional configuration of an information processor.

FIG. 9 is a flowchart illustrating operation example 1 of the storage-retrieval management system according to the embodiment.

FIG. 10 is a diagram illustrating an example of food item management information.

FIG. 11 is a sequence diagram of operation example 2 of the storage-retrieval management system according to the embodiment.

FIG. 12 is a diagram illustrating an example of a display screen showing details of the food item management information.

### DESCRIPTION OF EMBODIMENTS

Hereinafter, exemplary embodiments will be specifically described with reference to the drawings. It should be noted that the embodiments described below merely illustrate general or specific examples of the present disclosure. The numerical values, shapes, materials, elements, the arrangement and connection of the elements, steps, the order of the steps, etc., described in the following embodiments are mere examples, and are therefore not intended to limit the present disclosure. Accordingly, among elements in the following embodiments, those not appearing in any of the independent claims will be described as optional elements.

It should be noted that the respective figures are schematic diagrams and are not necessarily precise illustrations. Furthermore, in the respective figures, elements that are substantially the same are given the same reference signs, and redundant descriptions may be omitted or simplified.

### EMBODIMENT

### Configuration

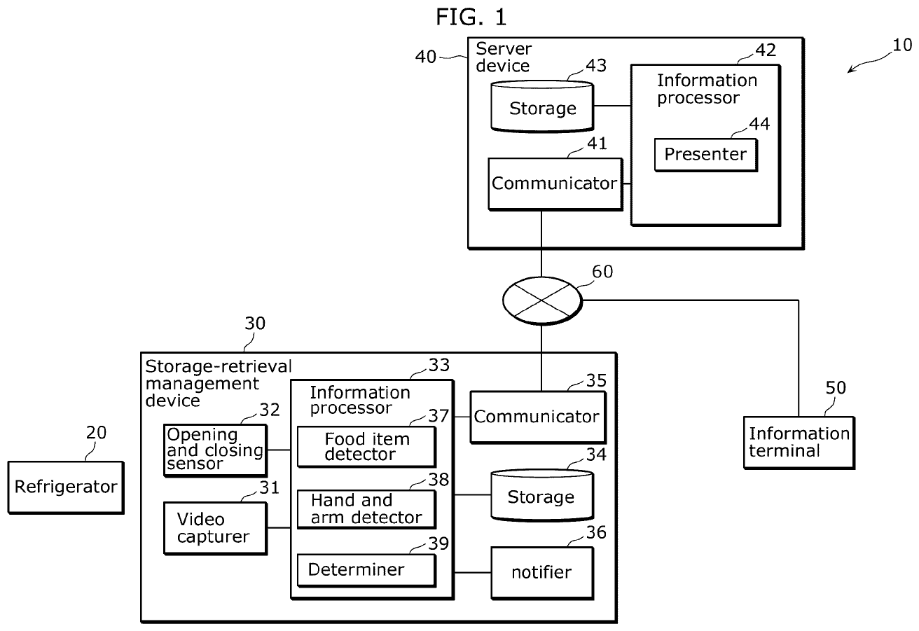

First, a configuration of a storage-retrieval management system according to an embodiment will be described. FIG. 1 is a block diagram illustrating a functional configuration of a storage-retrieval management system according to an embodiment.

Storage-retrieval management system 10 illustrated in FIG. 1 is a system for managing food items stored in refrigerator 20. Storage-retrieval management system 10 includes refrigerator 20, storage-retrieval management device 30, server device 40, and information terminal 50.

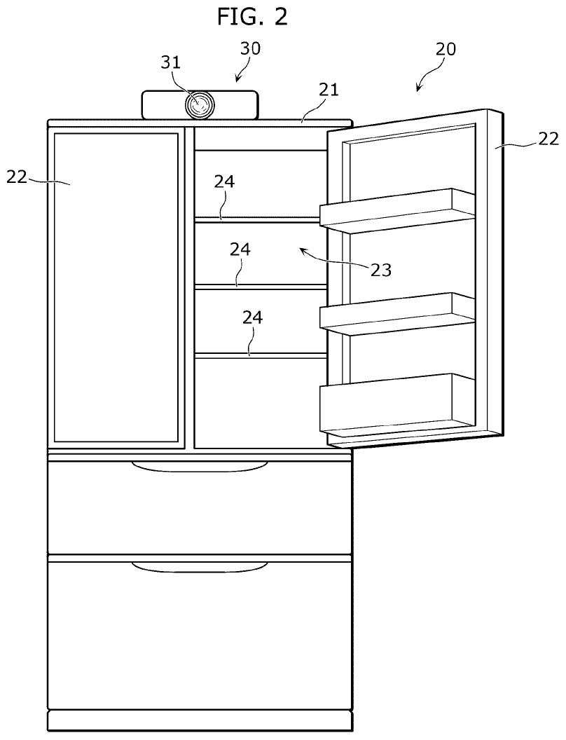

Refrigerator 20 is an example of a repository that is provided in a home of a user, and refrigerates food items. FIG. 2 is an external view of refrigerator 20 (and storage-retrieval management device 30). As illustrated in FIG. 2, refrigerator 20 includes main body 21, doors 22 that cover an opening of main body 21, and a plurality of shelves 24 provided in storage space 23 in main body 21. Once door 22 is opened, refrigerator 20 is in a state in which food items can be placed on each of the plurality of shelves 24 (i.e., food items can be stored in storage space 23). In the example in FIG. 2, refrigerator 20 includes two doors 22 that cover storage space 23, but may include one door 22 that covers storage space 23.

Storage-retrieval management device 30 is, for example, attached to a top surface of refrigerator 20, and performs information processing for managing food items stored in refrigerator 20. Storage-retrieval management device 30 is, for example, retrofitted onto an existing refrigerator 20, but may be provided in refrigerator 20. In other words, storage-retrieval management device 30 may be provided as a unit separate from refrigerator 20, and may be provided as a device manufactured as a single unit with refrigerator 20. As illustrated in FIG. 1, storage-retrieval management device 30 includes video capturer 31, opening and closing sensor 32, information processor 33, storage 34, communicator 35, and notifier 36.

Video capturer 31 captures video showing a scene in which a food item is put into or taken out of refrigerator 20 from above refrigerator 20. In other words, video capturer 31 captures video of refrigerator 20 (video of the opening of refrigerator 20) in a state in which door 22 is open, for example, as viewed from above refrigerator 20. Video capturer 31 is, for example, implemented by a camera that includes a fisheye lens, but may be implemented by a camera that includes a typical lens. It should be noted that the video includes a plurality of images that have been captured in succession, and each of the plurality of images can also be described as a frame.

Video capturer 31 is attached to a casing of storage-retrieval management device 30, but may be attached to refrigerator 20 apart from the casing of storage-retrieval management device 30. In other words, video capturer 31 may be retrofitted onto refrigerator 20. In this case, video capturer 31 includes a magnet, suction cup, clip, or the like as a structure with which video capturer 31 can be retrofitted onto refrigerator 20.

Opening and closing sensor 32 detects the opening and closing of door 22 (extent of opening) by measuring the distance from opening and closing sensor 32 to door 22 in an upper portion of refrigerator 20. Opening and closing sensor 32 is, for example, implement by an infrared distance measurement sensor. Opening and closing sensor 32 can individually detect the opening and closing of door 22 on the right side and the opening and closing of door 22 on the left side by individually measuring the distance from opening and closing sensor 32 to door 22 on the right side and the distance from opening and closing sensor 32 to door 22 on the left side.

It should be noted that opening and closing sensor 32 may be implemented by an angle sensor or the like in place of an infrared distance measurement sensor. Furthermore, opening and closing sensor 32 may be provided by refrigerator 20, and in this case, storage-retrieval management device 30 need not include opening and closing sensor 32.

Information processor 33 performs information processing for managing food items stored in refrigerator 20. Information processor 33 is implemented, for example, as a microcomputer, but may be implemented as a processor or a dedicated circuit. Information processor 33 includes food item detector 37, hand and arm detector 38, and determiner 39 as functional elements. The functionality of food item detector 37, hand and arm detector 38, and determiner 39 is, for example, implemented as a microcomputer or the like that includes information processor 33 executing a computer program stored in storage 34. The functionality of food item detector 37, hand and arm detector 38, and determiner 39 will later be described in detail.

Storage 34 is a storage device in which a computer program executed by information processor 33 and various information (food item management information and the like as described later) necessary for the above-mentioned information processing are stored. Storage 34 is implemented as semiconductor memory, for example.

Communicator 35 is a communication circuit for storage-retrieval management device 30 communicating with server device 40 via wide-area communication network 60. Communicator 35 is, for example, a wireless communication circuit that performs wireless communication, but may be a wired communication circuit that performs wired communication. The communication standard for communication performed by communicator 35 is not particularly limited.

Notifier 36 gives notice such as when a food item has been recognized as an object that is subject to inventory management or an error related to video capturer 31 has occurred. Notifier 36 is, for example, implemented by a loudspeaker, buzzer, or the like, and notifies by emitting sound, but may be implemented by a light-emitting element, such as a light emitting diode (LED) or the like, and may notify by emitting light.

Server device 40 is a computer disposed outside of a facility in which refrigerator 20 is provided, and specifically is a cloud server. Server device 40 performs information processing for presenting information on food items stored in refrigerator 20. Server device 40 includes communicator 41, information processor 42, and storage 43.

Communicator 41 is a communication circuit for server device 40 communicating with storage-retrieval management device 30 and information terminal 50 via wide-area communication network 60. Communicator 41 is, for example, a wired communication circuit that performs wired communication, but may be a wireless communication circuit that performs wireless communication. The communication standard for communication performed by communicator 41 is not particularly limited.

Information processor 42 performs information processing for presenting information on food items stored in refrigerator 20. Information processor 42 is implemented, for example, as a microcomputer, but may be implemented as a processor or a dedicated circuit. Information processor 42 includes presenter 44 as a functional element. The functionality of presenter 44 is, for example, implemented as a microcomputer or the like that includes information processor 42 executing a computer program stored in storage 43. The functionality of presenter 44 will later be described in detail.

Storage 43 is a storage device in which a computer program executed by information processor 42 and various information necessary for the above-mentioned information processing are stored. Storage 43 is implemented as semiconductor memory, for example.

Information terminal 50 is an information terminal that is possessed by a user. The user uses information terminal 50 for checking food items stored in refrigerator 20 (details of food item management information) from a place away from home or the like. Information terminal 50 is, for example, a portable information terminal 50, such as a smartphone, tablet device, or the like, but may be a stationary information terminal, such as a personal computer or the like.

### Determining the Four States

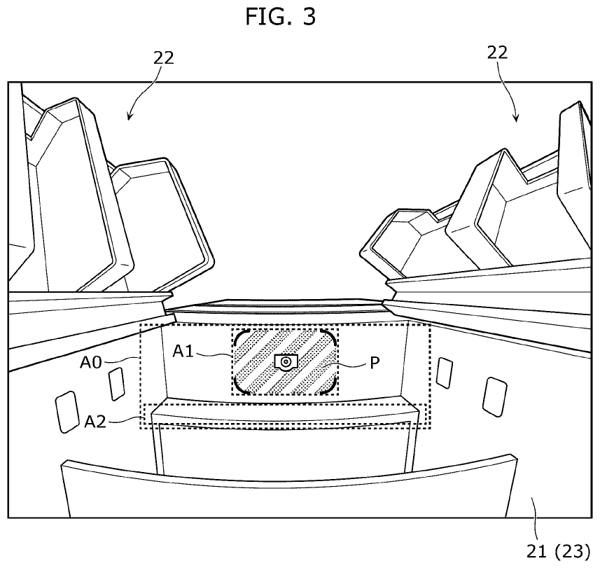

Next, operations for inventory management of food items in refrigerator 20 performed by storage-retrieval management system 10 will be described. When the user stores a food item in refrigerator 20 or retrieves a food item from refrigerator 20, and the user wishes to make the food item an object that is subject to inventory management, the food item is temporarily held still above a designated region provided on the bottom surface of storage space 23. In other words, the user intentionally performs a movement in which the food item is held above the designated region. Storage-retrieval management device 30 can detect that the food item is held still by the user above the designated region by performing image processing of the video captured by video capturer 31. FIG. 3 is a diagram illustrating an example of a video captured by video capturer 31.

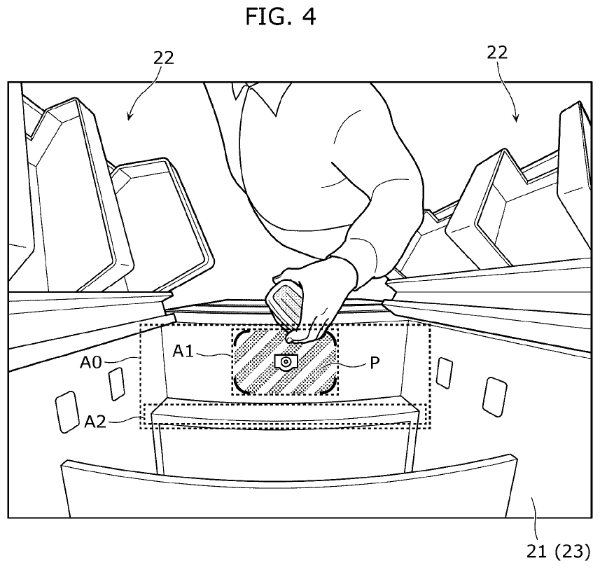

FIG. 3 is a diagram illustrating the entire video capturing range of video capturer 31. In the video illustrated in FIG. 3, the opening of refrigerator 20, storage space 23 that is located behind the opening, and the like are visible. Furthermore, designated region P is also visible in the video. Designated region P is a region of the bottom surface of storage space 23 (inner surface of refrigerator 20) on which a predetermined pattern is drawn, and is an actual region. Although a user (person) is not visible in FIG. 3, as illustrated in FIG. 4 through FIG. 6 and the like as described later, a user located in front of the opening is also visible in the video.

Note that in the description of image processing of the video that will later be provided, predetermined range A0 that is equivalent to a portion of the video capturing range of video capturer 31 will be subject to image processing, rather than the entire video capturing range of video capturer 31. In other words, in the description of image processing that will later be provided, the terms “frame”, “image”, “video”, and the like are used to refer to a portion of predetermined range A0 rather than the entire video capturing range of video capturer 31.

Predetermined range A0 is set with first region A1 and second region A2. First region A1 and second region A2 are virtual regions that are used in image processing, and are illustrated in FIG. 3 by dashed lines. First region A1 is set so as to include designated region P. First region A1 and designated region P are set in locations appropriate for holding an article that is an object that the user wishes to make subject to inventory management.

The shapes and locations of designated region P and first region A1 are merely examples, and the shapes and locations of the designated region and first region A1 may be appropriately determined based on experience or experiments by the designer and the like of storage-retrieval management system 10. Note that designated region P need not be explicitly provided, and first region A1 may be set in at least a portion of the bottom surface of storage space 23 (surface that is a single color, such as white or the like).

When the user stores a food item, it can be considered that the video captured by video capturer 31 changes as illustrated in FIG. 3 through FIG. 6.

FIG. 3 is a diagram illustrating the video before a food item is stored by the user, and this state is defined as a STANDBY state. In the STANDBY state, neither a hand nor an arm of the user nor the food item held by the user (hereinafter referred to as “the arm or the like of the user”) is visible in predetermined range A0.

FIG. 4 is a diagram illustrating the video when the user moves the food item above the designated region, and this state is defined as a READY state. In the READY state, the arm or the like of the user is visible in first region A1 of the video, and the arm or the like of the user is in a state in which it is moving.

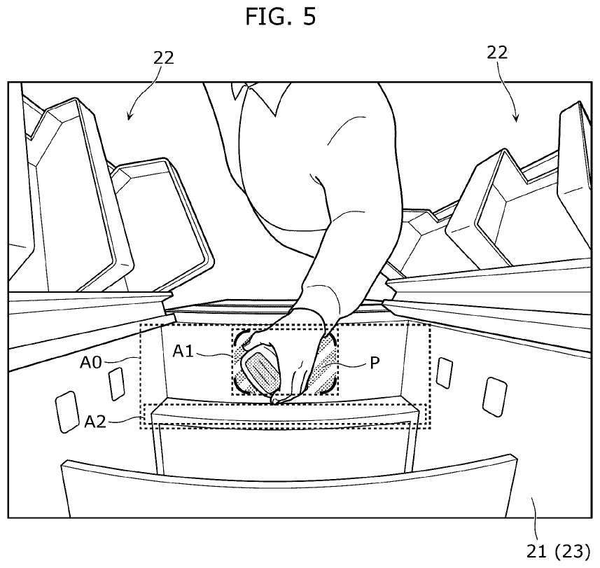

FIG. 5 is a diagram illustrating the video when the food item is held still by the user above the designated region, and this state is defined as a SET state. In the SET state, the arm or the like of the user (in this case the food item) is visible in first region A1 of the video, and the arm or the like of the user is in a state in which it is held still (or more accurately, movement is minimal).

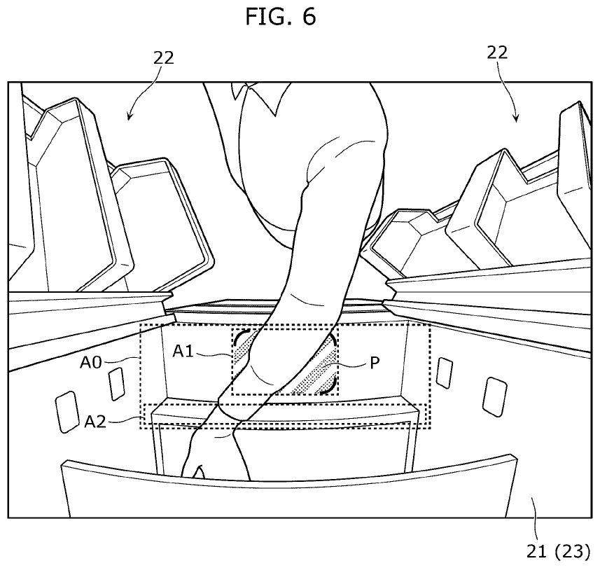

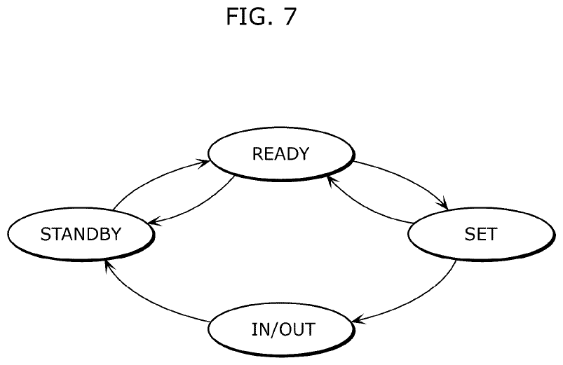

FIG. 6 is a diagram illustrating the video when the food item is stored in storage space 23 (placed on shelf 24) by the user, and this state is defined as an IN/OUT state. In the IN/OUT state, the arm or the like of the user is visible in first region A1 of the video, and the arm or the like of the user is in a state in which it is moving. After the IN/OUT state, once the food item has been placed by the user, the process returns to the STANDBY state. The STANDBY state, the READY state, the SET state, and the IN/OUT state described above can be represented as a state transition diagram as illustrated in FIG. 7. FIG. 7 is a state transition diagram that illustrates the STANDBY state, the READY state, the SET state, and the IN/OUT state.

Although an example of such a video is not illustrated in the figures, when the user retrieves a food item, the process transitions between the STANDBY state, the READY state, the SET state, the IN/OUT state, and the STANDBY state in order in the same manner as when a food item is stored.

### Image Processing for Determining the Four States

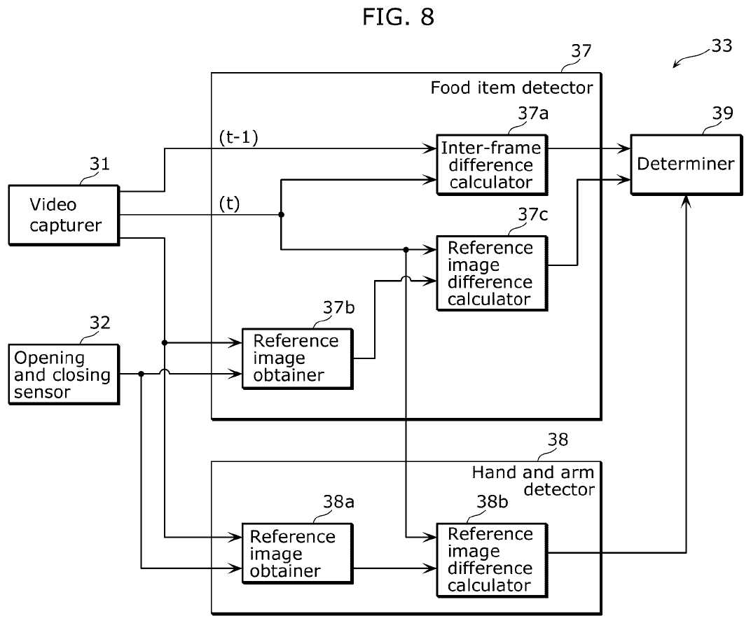

Storage-retrieval management device 30 can manage food items by determining which state of the four above-mentioned states it is in based on a difference in pixel values between different frames included in the video (whether there is movement) and a difference in pixel values between a first reference image and a frame included in the video (whether an arm or the like of a user is visible). Next, a method for determining the four states will be described with reference to FIG. 8. FIG. 8 is a block diagram of a functional configuration of information processor 33 provided in storage-retrieval management device 30. Video capturer 31 and opening and closing sensor 32 are also shown in FIG. 8.

Note in the following description of FIG. 8 (description of image processing for determining the four states), the terms “frame”, “image”, “video”, and the like are used to refer to a portion of predetermined range A0 rather than the entire video capturing range of video capturer 31. In image processing, although an image is temporarily stored in storage 34, this process will be omitted in the following description.

As illustrated in FIG. 8, information processor 33 includes food item detector 37 and determiner 39. Food item detector 37 includes inter-frame difference calculator 37a, reference image obtainer 37b, and reference image difference calculator 37c.

First, a description will be provided on the determination of whether an object visible in the video is moving that is performed by inter-frame difference calculator 37a. Inter-frame difference calculator 37a calculates a difference between a pixel value of a pixel included in a frame captured by video capturer 31 at time t-1 and a pixel value of a pixel included in a frame captured at current time t. For example, inter-frame difference calculator 37a calculates a difference between pixel values of pixels that correspond to each other between a frame captured at time t-1 and a frame captured at current time t. When a total number of pixels included in a frame is m (m being a natural number), m number of differences are calculated. Assuming that a total number of differences greater than a predetermined threshold value, of the m number of differences, is n (n being a natural number), when n/m is greater than or equal to a predetermined proportion, inter-frame difference calculator 37a can determine that an object (the arm or the like of the user) visible in the video is moving, and when n/m is less than the predetermined proportion, inter-frame difference calculator 37a can determine that the object (the arm or the like of the user) visible in the video is not moving. The predetermined threshold value and the predetermined proportion may be appropriately determined based on experience or experiments.

Next, a description will be given on the determination of whether an object, such as the arm or the like of the user, is visible in first region A1 of the video that is performed by reference image obtainer 37b and reference image difference calculator 37c. Reference image obtainer 37b obtains a first reference image that is captured by video capturer 31. The first reference image is an image in which no objects other than refrigerator 20 are visible in first region A1 as illustrated in FIG. 3.

For example, when opening and closing sensor 32 detects that at least one of the two doors 22 has been opened, reference image obtainer 37b causes a first reference image to be captured by video capturer 31, and obtains the first reference image. In other words, each time door 22 is opened, reference image obtainer 37b obtains a new first reference image. Accordingly, a first reference image that shows the latest state inside of refrigerator 20 can be obtained. Since there is a rule that food items cannot be placed on top of designated region P when storing food items in refrigerator 20, in an image captured immediately after door 22 is opened, objects other than refrigerator 20 will not be visible in first region A1 that includes designated region P, and thus, the image can be used as a first reference image.

It should be noted that a first reference image need not be obtained by being triggered by the opening of door 22, and alternatively, a first reference image may be captured by video capturer 31 at a time when storage-retrieval management device 30 is newly installed (during initial setup), and thereafter the same first reference image may continue to be used instead, for example. Furthermore, the first reference image may be captured at an arbitrary timing, and the first reference image obtained by being triggered by the opening of door 22 may be periodically updated while door 22 of the refrigerator is open, for example.

When capturing a first reference image at an arbitrary timing, reference image obtainer 37b first checks that no objects other than refrigerator 20 are visible in first region A1 of the image captured, before obtaining (using) the image as the first reference image. For example, when designated region P is a region in which a predetermined pattern is drawn, and when reference image obtainer 37b detects the predetermined pattern in first region A1 by pattern matching, it can be determined that no objects other than refrigerator 20 are visible in first region A1. Furthermore, when designated region P is not explicitly provided and first region A1 is set in a portion of a bottom surface of storage space 23 (surface that is a single color, such as white or the like), and when reference image obtainer 37b does not detect an edge in first region A1 by edge detection, it can be determined that no objects other than refrigerator 20 are visible in first region A1.

Reference image difference calculator 37c calculates a difference between a pixel value of a pixel included in first region A1 of the first reference image obtained by reference image obtainer 37b and a pixel value of a pixel included in first region A1 of a frame captured at current time t. Reference image difference calculator 37c calculates a difference between pixel values of pixels that correspond to each other between first region A1 of the first reference image and first region A1 of the frame captured at current time t, for example. When a total number of pixels included in first region A1 is p (p being a natural number), p number of differences are calculated. Assuming that a total number of differences greater than a predetermined threshold value, of the p number of differences, is q (q being a natural number), when q/p is greater than or equal to a predetermined proportion, reference image difference calculator 37c can determine that the arm or the like of the user is present in first region A1, and when q/p is less than the predetermined proportion, reference image difference calculator 37c can determine that the arm or the like of the user is not present. The predetermined threshold value and the predetermined proportion may be appropriately determined based on experience or experiments.

Next, the determining of the four states by determiner 39 will be described. Determiner 39 determines which of the four states the current state is, based on a determination result of inter-frame difference calculator 37a (presence of objects that are visible in video), a determination result of reference image difference calculator 37c (presence of the arm or the like of the user in first region A1), and the state transition diagram (FIG. 7).

Immediately after door 22 is opened, there is no movement of objects that are visible in the video and the arm or the like of the user is not located in first region A1 since the arm or the like of the user is not visible in the video (predetermined range AO). Consequently, determiner 39 determines the state to be the STANDBY state. After the STANDBY state, once the arm or the like of the user enters inside of refrigerator 20, determiner 39 determines that the state has transitioned to a READY state since the arm or the like of the user visible in the video is moving and the arm or the like of the user is located in fist region A1.

Afterwards, when a food item is held still by the user above designated region P, and the user has the intention of making the food item subject to management, determiner 39 determines that the state has transitioned to a SET state since the arm or the like of the user visible in the video will stop moving (movement will decrease) and the arm or the like of the user (or in this case the food item) will be located in first region A1.

Once determiner 39 determines that the SET state has continued for a fixed period of time, determiner 39 determines the state to be the IN/OUT state. The IN/OUT state is a state in which the user performs movements to store or retrieve food items, and is a state in which the arm or the like of the user visible in the video is moving and the arm or the like of the user is located in first region A1. On the other hand, if determiner 39 determines that the SET state did not continue for a fixed period of time (time during which the SET state continued did not reach the fixed period), determiner 39 determines that the state returns to the READY state.

After the IN/OUT state, when the user pulls their hand out of refrigerator 20, there is no movement of objects that are visible in the video and the arm or the like of the user is not located in first region A1 since the arm or the like of the user is not visible in the video (predetermined range A0). Consequently, determiner 39 determines the state to be the STANDBY state.

As described above, information processor 33 includes food item detector 37 that detects whether a stationary object other than refrigerator 20 is visible in first region A1 of the video (or more specifically, a food item has come to a stop in first region A1) by performing image processing on the video captured by video capturer 31. Accordingly, under a condition that it is detected that a stationary object other than refrigerator 20 is visible in first region A1, information processor 33 (determiner 39) can determine that the stationary object is an object that is subject to inventory management. More specifically, when the state transitions in order starting from the STANDBY state, to the READY state, the SET state, the IN/OUT state, and back to the STANDBY state, information processor 33 can determine that a food item subject to inventory management has been stored (or retrieved).

### Configuration to Prevent Erroneous Determination

However, when the user is storing a food item that is not subject to inventory management, since the food item will not be held still by the user above designated region P, the user will place their hand deep inside of refrigerator 20 as illustrated in FIG. 6 in a situation where the state has not yet transitioned from the READY state to the SET state and is determined to be remaining in the READY state. Here, when the user stops moving with their hand deep inside of refrigerator 20 as illustrated in FIG. 6, determiner 39 may erroneously determine that the state has transitioned from the READY state to the SET state.

In view of this, second region A2 is set in the video (predetermined range A0), and when the arm or the like of the user is visible in second region A2, information processor 33 does not determine the state to be the SET state even when the arm or the like of the user visible in the video stops moving and the arm or the like of the user is located in first region A1. In other words, under a condition that the arm or the like of the user visible in the video stops moving and the arm or the like of the user is located in first region A1, determiner 39 determines whether the state transitions to the SET state based on an additional condition that the arm or the like of the user is not visible in second region A2.

As illustrated in FIG. 3 through FIG. 6, second region A2 is located inward from first region A1 in a depth direction of refrigerator 20 (up-and-down direction in FIG. 3 through FIG. 6). A length of second region A2 in the depth direction of refrigerator 20 is shorter than a length of first region A1 in the depth direction, and a length of second region A2 in a width direction of refrigerator 20 (left-and-right direction in FIG. 3 through FIG. 6) is longer than a length of first region A1 in the width direction. Second region A2 is set in a location that is considered to be a location in which the hand or the arm of the user is not visible when the user is holding an article that the user wishes to make subject to inventory management, and when the article is positioned in first region A1.

It should be noted that such a second region A2 is merely an example, and the shape and location of second region A2 may be appropriately determined based on experience or experiments by the designer and the like of storage-retrieval management system 10.

As illustrated in FIG. 8 as described above, information processor 33 includes hand and arm detector 38 as an element for determining whether the arm or the like of the user is visible in second region A2. Hand and arm detector 38 includes reference image obtainer 38a and reference image difference calculator 38b. Next, a description will be provided on the determination of whether an object, such as the arm or the like of the user, is visible in second region A2 of the video that is performed by reference image obtainer 38a and reference image difference calculator 38b. Reference image obtainer 38a obtains a second reference image captured by video capturer 31. The second reference image is an image in which no objects other than refrigerator 20 are visible in second region A2 as illustrated in FIG. 3.

For example, when opening and closing sensor 32 detects that at least one of the two doors 22 has been opened, reference image obtainer 38a causes a second reference image to be captured by video capturer 31, and obtains the second reference image. In other words, each time door 22 is opened, reference image obtainer 38a obtains a new second reference image. Accordingly, a second reference image that shows the latest state inside of refrigerator 20 can be obtained.

It should be noted that a second reference image need not be obtained by being triggered by the opening of door 22, and alternatively, a second reference image may be captured by video capturer 31 at a time when storage-retrieval management device 30 is newly installed (during initial setup), and thereafter the same reference image may continue to be used instead, for example. Furthermore, the second reference image may be captured at an arbitrary timing, and the reference image obtained by being triggered by the opening of door 22 may be periodically updated while door 22 of the refrigerator is open, for example. It should be noted that the first reference image may be used as a second reference image, and in this case, the obtaining of the second reference image may be skipped.

Reference image difference calculator 38b calculates a difference between a pixel value of a pixel included in second region A2 of the second reference image obtained by reference image obtainer 38a and a pixel value of a pixel included in second region A2 of a frame captured at current time t. Reference image difference calculator 38b calculates a difference between pixel values of pixels that correspond to each other between second region A2 of the second reference image and second region A2 of the frame captured at current time t, for example. When the total number of pixels included in second region A2 is x (x being a natural number), x number of differences are calculated. Assuming that the total number of differences greater than a predetermined threshold value, of the x number of differences, is y (y being a natural number), when y/x is greater than or equal to a predetermined proportion, reference image difference calculator 38b can determine that the arm or the like of the user is present in second region A2, and when y/x is less than the predetermined proportion, reference image difference calculator 38b can determine that the arm or the like of the user is not present. The predetermined threshold value and the predetermined proportion may be appropriately determined based on experience or experiments.

In this manner, hand and arm detector 38 detects whether a hand or an arm is visible in second region A2 of the video by performing image processing on the video captured by video capturer 31. Accordingly, under a condition that it is detected that a stationary object other than refrigerator 20 is visible in first region A1 (specifically, that a food item has come to a stop in first region A1) during a period in which a hand or an arm is not visible in second region A2, determiner 39 can determine that the stationary object is an object that is subject to inventory management. Accordingly, erroneous determination that the state has transitioned from the READY state to the SET state can be prevented.

### Operation Example 1

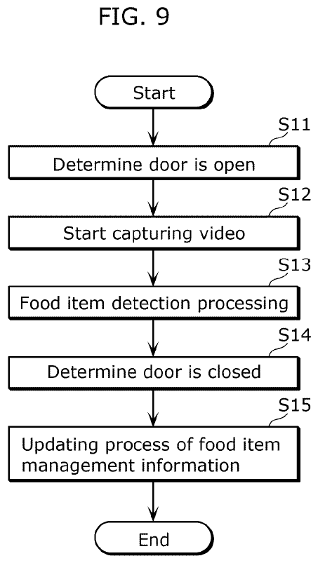

Next, operations for inventory management of food items will be described as a specific operation example 1 of storage-retrieval management system 10. FIG. 9 is a flowchart illustrating operation example 1 of storage-retrieval management system 10.

First information processor 33 of storage-retrieval management device 30 determines that at least one of the two doors 22 is open based on a detection result of opening and closing sensor 32 (S11), and then video capturer 31 is activated and video capturing by video capturer 31 is started (S12).

Next, information processor 33 performs food item detection processing (S13). In the food item detection processing, information processor 33 determines whether a food item is stored or retrieved by performing the above-mentioned determining of the four states.

It should be noted that when a food item is held still by the user above designated region P and the state transitions from the SET state to the IN/OUT state, information processor 33 may notify the user that the food item has been recognized as being subject to inventory management by using notifier 36. For example, when notifier 36 is implemented by a loudspeaker, notifier 36 outputs a sound, voice message, or the like indicating that the food item has been recognized as being subject to inventory management. For example, when notifier 36 is implemented by a light-emitting element, notifier 36 notifies that the food item has been recognized as being subject to inventory management by emitting light.

Accordingly, the user can easily grasp that the food item has been successfully held still (food item has been made subject to inventory management).

Furthermore, for example, information processor 33 temporarily stores a frame in which the state transitions from the SET state to the IN/OUT state in storage 34.

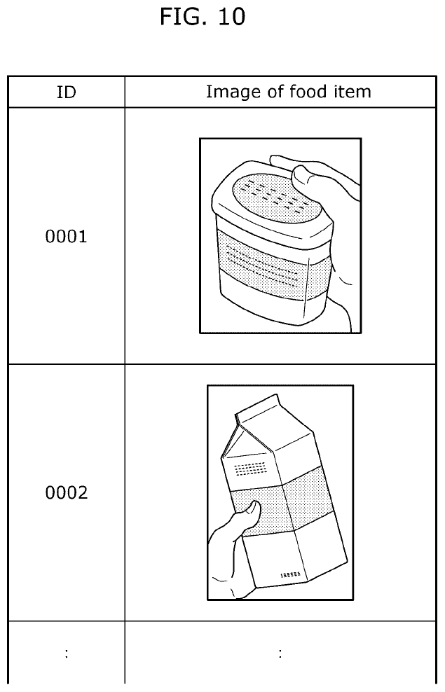

Afterwards, information processor 33 determines that both of the two doors 22 are closed based on a detection result of opening and closing sensor 32 (S14), and then an updating process of the food item management information is performed (S15). FIG. 10 is one example of a diagram illustrating food item management information, and food item IDs and images of food items are stored in association with each other in the food item management information. The food item management information is information provided as a list of the food items in refrigerator 20 at the point in time of the above-mentioned step S11, and stated differently, is inventory list information.

In step S15, information processor 33 extracts a portion of the frame in which the food item is visible (portion in the vicinity of first region A1) from the frame temporarily stored in step S13 as an image of the food item. When a new food item is stored in step S11 through step S14, information processor 33 assigns an ID to the extracted image of the food item, which are then added to the food item management information. On the other hand, when a food item is retrieved in step S11 through step S14, information processor 33 deletes the image of the food item among the one or more images of food items included in the food item management information that is most similar to the extracted image of the food item. In this case, information processor 33 performs a process to determine a similarity of the image by using various existing algorithms.

Note that it is determined whether a food item is stored or retrieved based on whether the arm or the like of the user is present in a third region (not illustrated in the figures; region near shelves 24, for example) in the video when in the IN/OUT state. For example, when the arm or the like of the user is present in the third region, determiner 39 determines that a food item has been stored, and when the arm or the like of the user is not present in the third region, determiner 39 determines that a food item has been retrieved. In the determining of whether the arm or the like of the user is present in the third region, the above-mentioned method using a reference image can be used to assist in this process.

As described above, storage-retrieval management system 10 is capable of managing the inventory of food items in refrigerator 20.

Note that when an error occurs related to video capturer 31, such as where it is impossible for video capturer 31 to capture a video, information processor 33 may notify that an error related to video capturer 31 has occurred using notifier 36. For example, when notifier 36 is implemented by a loudspeaker, notifier 36 outputs a voice message or the like indicating that an error has occurred. For example, when notifier 36 is implemented by a light-emitting element, notifier 36 notifies that an error has occurred by emitting light.

In this manner, if notice is given when an error related to video capturer 31 occurs, it is possible for the user take measures to handle the error.

### Operation Example 2

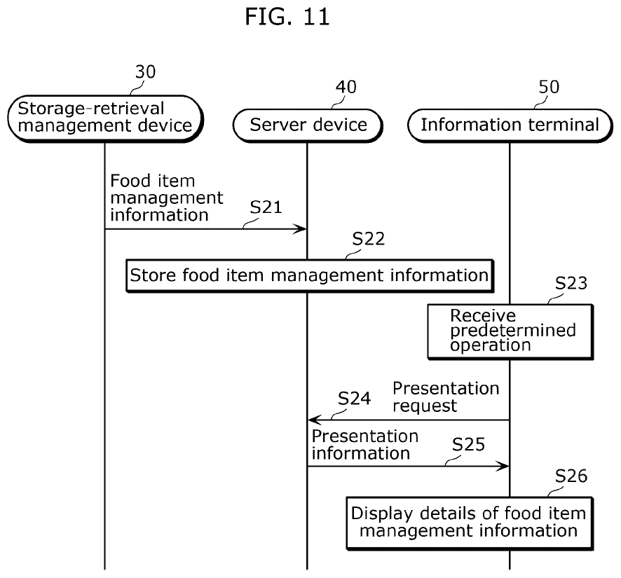

Next, operations for presenting food items stored in refrigerator 20 will be described as operation example 2 of storage-retrieval management system 10. FIG. 11 is a sequence diagram of operation example 2 of storage-retrieval management system 10.

Communicator 35 of storage-retrieval management device 30 transmits food item management information to server device 40 (S21). Communicator 41 of server device 40 receives the food item management information, and presenter 44 stores the food item management information received in storage 43 (S22). Communicator 35 of storage-retrieval management device 30 transmits the food item management information to server device 40 each time the updating process of the food item management information is performed, for example. Accordingly, the latest food item management information is stored in storage 43 of server device 40. It should be noted that the food item management information may be transmitted to server device 40 from storage-retrieval management device 30 in a periodic manner, such as once during each predetermined period of time.

However, when a user performs a predetermined operation to check a food item (details of the food item management information) stored in refrigerator 20 on information terminal 50 from a place away from home or the like, information terminal 50 receives this predetermined operation (S23), and a presentation request is transmitted to server device 40 based on the predetermined operation received (S24).

Communicator 41 of server device 40 receives the presentation request. Presenter 44 transmits presentation information for presenting details of the food item management information stored in storage 43 to information terminal 50 based on the presentation request received (S25). More specifically, the presentation information is transmitted by communicator 41.

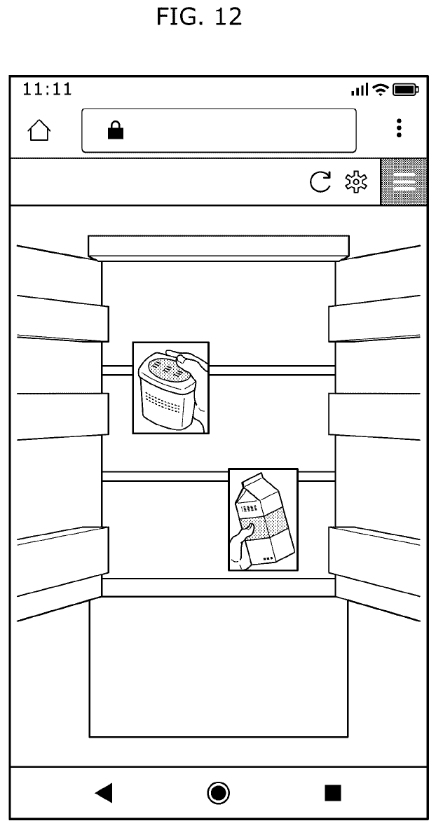

Information terminal 50 receives the presentation information and displays a display screen that indicates the details of the food item management information on a display provided in information terminal 50 based on the presentation information received (S26). FIG. 12 is a diagram illustrating an example of a display screen showing details of the food item management information. In the display screen in FIG. 12, images of food items included in the food item management information (images extracted from video captured by video capturer 31) are overlaid on a background image that is a mock-up depiction of the contents of refrigerator 20.

In this manner, the user of storage-retrieval management system 10 can check the food items stored in refrigerator 20 in the user's home from a place away from home or the like.

### Variations

In the above-mentioned embodiment, a configuration to prevent erroneous determination of a food item as being an object that is subject to inventory management was described. Storage-retrieval management system 10 may include a configuration to exclude food items that have been erroneously determined as being objects that are subject to inventory management.

As described above, when a food item is determined to be an object that is subject to inventory management, notifier 36 gives notice indicating this. Here, under a condition that the user performs a predetermined gesture (such as by spreading out their fingers in an open-handed gesture and holding still) in first region A1 within a predetermined period of time after notice is given, storage-retrieval management system 10 may exclude the food item that has been erroneously determined as being an object that is subject to inventory management.

### Other Variations

In the above-mentioned embodiment, refrigerator 20 may be a refrigerator for common household use or may be a refrigerator for displaying products used in a retail store, such as a convenience store, or other commercial refrigerator.

Furthermore, refrigerator 20 is an example of a repository, and in the present disclosure, another type of repository that does not have a refrigeration function may be used for implementation. Furthermore, articles (i.e., objects) stored in the repository are not limited to food items, and may be other types of articles. Articles other than food items can conceivably

### Advantageous Effects, etc.

Hereinafter, examples are provided of techniques achieved by the information disclosed in the Description, and the advantageous effects and the like achieved by the techniques are described.

Technique 1 is storage-retrieval management system 10 that includes: video capturer 31 that captures a video of an opening of a repository viewed from above; food item detector 37 that detects whether a stationary object other than the repository is visible in first region A1 of the video by performing image processing on the video; hand and arm detector 38 that detects whether a hand or an arm of a user located in front of the opening is visible in second region A2 of the video by performing image processing on the video; and determiner 39 that determines, under a condition that the stationary object other than the repository is detected as being visible in first region A1 during a period in which the hand or the arm of the user is not visible in second region A2, that the stationary object is an object that is subject to inventory management. Food item detector 37 is an example of a first detector, and hand and arm detector 38 is an example of a second detector.

Such a storage-retrieval management system 10 can determine that an article held still by the user in first region A1 is an object that is subject to inventory management. In other words, storage-retrieval management system 10 can determine that the article is an object that is subject to inventory management based on an intentional movement of the user. Furthermore, second region A2 is set in a location that is considered to be a location in which the hand or the arm of the user is not visible when the user intentionally positions the article that the user wishes to make subject to inventory management in first region A1. By setting second region A2 in this manner, storage-retrieval management system 10 can prevent erroneous determination of an object as being subject to inventory management.

Technique 2 is storage-retrieval management system 10 according to technique 1, in which hand and arm detector 38: obtains a second reference image captured in advance by video capturer 31; and detects whether the hand or the arm is visible in second region A2 based on a difference between a pixel value of a pixel in second region A2 in the second reference image obtained and a pixel value of a pixel in second region A2 in an image included in the video.

Such a storage-retrieval management system 10 can detect whether the hand or the arm is visible in second region A2 by comparing the second reference image to a current image (frame).

Technique 3 is storage-retrieval management system 10 according to technique 2, in which hand and arm detector 38 is capable of changing the second reference image.

Such a storage-retrieval management system 10 can change (update) the second reference image.

Technique 4 is storage-retrieval management system 10 according to technique 3, in which the opening includes door 22, and each time door 22 is opened, hand and arm detector 38 updates the second reference image using an image captured by video capturer 31 when door 22 is opened as the second reference image.

Such a storage-retrieval management system 10 can update the second reference image each time door 22 is opened.

Technique 5 is storage-retrieval management system 10 according to any one of techniques 1 to 4, in which food item detector 37: obtains a first reference image captured in advance by video capturer 31; and detects whether the stationary object other than the repository is present in first region A1 based on (i) a difference between a pixel value of a pixel in first region A1 in the first reference image obtained and a pixel value of a pixel in first region A1 in an image included in the video and (ii) a difference between pixel values in a plurality of images included in the video.

Such a storage-retrieval management system 10 can detect whether the stationary object is present by comparing the first reference image to the current image (frame), and by comparing the plurality of images (frames) included in the video with each other.

Technique 6 is storage-retrieval management system 10 according to technique 5, in which food item detector 37 is capable of changing the first reference image.

Such a storage-retrieval management system 10 can change (update) the first reference image.

Technique 7 is storage-retrieval management system 10 according to technique 6, in which the opening includes door 22, and each time door 22 is opened food item detector 37 updates the first reference image using an image captured by video capturer 31 when door 22 is opened as the first reference image.

Such a storage-retrieval management system 10 can update the first reference image each time door 22 is opened.

Technique 8 is storage-retrieval management system 10 according to any one of techniques 1 to 7, in which first region A1 is a region that includes an inner surface of the repository visible in the video.

Such a storage-retrieval management system 10 can use, as the first region, a region in which the inner surface of the repository is visible in the video.

Technique 9 is storage-retrieval management system 10 according to any one of techniques 1 to 8, in which the inner surface of the repository visible in the video includes designated region P in which a predetermined pattern is drawn, and first region A1 includes designated region P.

Such a designated region P is useful as a visual indicator of the location at which the article that the user wishes to make subject to inventory management should be held still.

Technique 10 is storage-retrieval management system 10 according to any one of techniques 1 to 9, in which second region A2 is located inward from first region A1 in a depth direction of the repository.

When such a second region A2 is set, it is considered that the hand or the arm of the user will not be visible in second region A2 when the user is holding the article that the user wishes to make subject to inventory management, and when the article is positioned in first region A1. Consequently, storage-retrieval management system 10 can prevent erroneous determination of the object as being subject to inventory management.

Technique 11 is storage-retrieval management system 10 according to any one of techniques 1 to 10, in which a length of second region A2 in a depth direction of the repository is shorter than a length of first region A1 in the depth direction.

Such a storage-retrieval management system 10 can prevent erroneous determination of an object as being subject to inventory management based on second region A2 having a length in the depth direction that is shorter than that of first region A1.

Technique 12 is storage-retrieval management system 10 according to any one of techniques 1 to 11, in which a length of second region A2 in a width direction of the repository is longer than a length of first region A1 in the width direction.

Such a storage-retrieval management system 10 can prevent erroneous determination of an object as being subject to inventory management based on second region A2 having a length in the width direction that is longer than that of first region A1.

Technique 13 is storage-retrieval management system 10 according to any one of techniques 1 to 12, further including: notifier 36 that notifies that an error related to video capturer 31 has occurred.

Such a storage-retrieval management system 10 can notify that an error related to video capturer 31 has occurred.

Technique 14 is storage-retrieval management system 10 according to any one of techniques 1 to 13, in which the repository is refrigerator 20.

Storage-retrieval management system 10 can determine whether the article is an object that is subject to inventory management for refrigerator 20.

Technique 15 is a storage-retrieval management method executed by a computer. The storage-retrieval management method includes: capturing a video of an opening of a repository viewed from above; detecting whether a stationary object other than the repository is visible in first region A1 of the video by performing image processing on the video; detecting whether a hand or an arm of a user located in front of the opening is visible in second region A2 of the video by performing image processing on the video; and determining, under a condition that the stationary object other than the repository is detected as being visible in first region A1 during a period in which the hand or the arm of the user is not visible in second region A2, that the stationary object is an object that is subject to inventory management.

Such a storage-retrieval management method can determine that the article is an object that is subject to inventory management based on the intentional movement of the user.

Technique 16 is a program for causing the computer to execute the storage-retrieval management method according to technique 15.

Such a program can determine that the article is an object that is subject to inventory management based on the intentional movement of the user.

### OTHER EMBODIMENTS

Although an embodiment has been described above, the present disclosure is not limited to the above embodiment.

For example, although the storage-retrieval management system is implemented as a plurality of devices in the above-mentioned embodiment, the storage-retrieval management system may be implemented as a single device. For example, the storage-retrieval management system may be implemented as a single device equivalent to the storage-retrieval management device according to the above-mentioned embodiment, and may be implemented as a single device equivalent to a server device. When implementing the storage-retrieval management system as a plurality of devices, the elements (specifically, the functional elements) included in the storage-retrieval management system may be assigned to the plurality of devices in any manner desired. For example, a portion or all of the processes described as being performed in the storage-retrieval management device according to the above-mentioned embodiment may be performed by a server device.

Furthermore, for example, the method of communication used for communication between devices according to the above-mentioned embodiment is not particularly limited. Furthermore, in communication between devices, communication may be performed via a relay device not illustrated in the figures. Furthermore, the transmission path of information described in the above-mentioned embodiment is not particularly limited to the transmission path illustrated in the sequence diagram.

For example, in the above-mentioned embodiment, a process executed by a specific processor may be executed by a different processor. Furthermore, the order of the plurality of processes may be changed, and the plurality of processes may be executed in parallel with each other.

Furthermore, in the above embodiment, each element may be implemented by executing a software program suitable for each element. The respective elements may be implemented by a program executer such as a CPU or a processor reading and executing a software program recorded on a recording medium such as a hard disk or semiconductor memory.

Furthermore, each element may be implemented as hardware. For example, each element may be a circuit (or an integrated circuit). Such circuits may be consolidated as a single circuit, and may be configured as individual circuits. Furthermore, such circuits may each be a general-purpose circuit or a dedicated circuit.

Furthermore, general and specific aspects of the present disclosure may be implemented as a system, a device, a method, an integrated circuit, a computer program, or a computer-readable recording medium such as a CD-ROM. Furthermore, general and specific aspects of the present disclosure may be implemented as a system, a device, a method, an integrated circuit, a computer program, a recording medium, or any combination thereof.

For example, the present disclosure may be implemented as a storage-retrieval management method of objects that is executed by a computer, and may be implemented as a program for causing a computer to execute such a storage-retrieval management method. The present disclosure may be implemented as a non-transitory computer-readable recording medium having recorded thereon such a program.

Forms obtained through various modifications to the foregoing embodiment that can be conceived by those skilled in the art, as well as forms realized by combining elements and functions in the foregoing embodiment without departing from the essence of the present disclosure are included within the scope of the present disclosure.

### Industrial Applicability

The storage-retrieval management system according to the present disclosure is applicable as a device that can manage articles in a repository.

### REFERENCE SIGNS LIST

10 storage-retrieval management system
20 refrigerator (repository)
21 main body
22 door
23 storage space
24 shelf
30 storage-retrieval management device
31 video capturer
32 opening and closing sensor
33, 42 information processor
34, 43 storage
35, 41 communicator
36 notifier
37 food item detector (first detector)
38 hand and arm detector (second detector)
39 determiner
40 server device
44 presenter
50 information terminal
60 wide-area communication network

1. A storage-retrieval management system comprising:
a video capturer that captures a video of an opening of a repository viewed from above;
a first detector that detects whether a stationary object other than the repository is visible in a first region of the video by performing image processing on the video;
a second detector that detects whether a hand or an arm of a user located in front of the opening is visible in a second region of the video by performing image processing on the video; and
a determiner that determines, under a condition that the stationary object other than the repository is detected as being visible in the first region during a period in which the hand or the arm of the user is not visible in the second region, that the stationary object is an object that is subject to inventory management.

2. The storage-retrieval management system according to claim 1, wherein
the second detector:
obtains a second reference image captured in advance by the video capturer; and
detects whether the hand or the arm is visible in the second region based on a difference between a pixel value of a pixel in the second region in the second reference image obtained and a pixel value of a pixel in the second region in an image included in the video.

3. The storage-retrieval management system according to claim 2, wherein
the second detector is capable of changing the second reference image.

4. The storage-retrieval management system according to claim 3, wherein
the opening includes a door, and
each time the door is opened, the second detector updates the second reference image using an image captured by the video capturer when the door is opened as the second reference image.

5. The storage-retrieval management system according to claim 1, wherein
the first detector:
obtains a first reference image captured in advance by the video capturer; and
detects whether the stationary object other than the repository is present in the first region based on (i) a difference between a pixel value of a pixel in the first region in the first reference image obtained and a pixel value of a pixel in the first region in an image included in the video and (ii) a difference between pixel values in a plurality of images included in the video.

6. The storage-retrieval management system according to claim 5, wherein
the first detector is capable of changing the first reference image.

7. The storage-retrieval management system according to claim 6, wherein
the opening includes a door, and
each time the door is opened the first detector updates the first reference image using an image captured by the video capturer when the door is opened as the first reference image.

8. The storage-retrieval management system according to claim 1, wherein
the first region is a region that includes an inner surface of the repository visible in the video.

9. The storage-retrieval management system according to claim 8, wherein
the inner surface of the repository visible in the video includes a designated region in which a predetermined pattern is drawn, and
the first region includes the designated region.

10. The storage-retrieval management system according to claim 1, wherein
the second region is located inward from the first region in a depth direction of the repository.

11. The storage-retrieval management system according to claim 1, wherein
a length of the second region in a depth direction of the repository is shorter than a length of the first region in the depth direction.

12. The storage-retrieval management system according to claim 1, wherein
a length of the second region in a width direction of the repository is longer than a length of the first region in the width direction.

13. The storage-retrieval management system according to claim 1, further comprising:
a notifier that notifies that an error related to the video capturer has occurred.

14. The storage-retrieval management system according to claim 1, wherein
the repository is a refrigerator.

15. A storage-retrieval management method executed by a computer, the storage-retrieval management method comprising:
capturing a video of an opening of a repository viewed from above;
detecting whether a stationary object other than the repository is visible in a first region of the video by performing image processing on the video;
detecting whether a hand or an arm of a user located in front of the opening is visible in a second region of the video by performing image processing on the video; and
determining, under a condition that the stationary object other than the repository is detected as being visible in the first region during a period in which the hand or the arm of the user is not visible in the second region, that the stationary object is an object that is subject to inventory management.

16. A non-transitory computer-readable recording medium having recorded thereon a program for causing the computer to execute the storage-retrieval management method according to claim 15.
